(19) United States
(12) Patent Application Publication
(10) Pub. No.: US 2010/0027406 A1
(43) Pub. Date: Feb. 4, 2010

(54) OPTICAL STORAGE MEDIUM COMPRISING TRACKS WITH DIFFERENT WIDTH AND RESPECTIVE PRODUCTION METHOD

(75) Inventors: Michael Krause, Villingen-Schwenningen (DE); Stephan Knappmann, Zimmen Ob Rottweil (DE)

Correspondence Address: Robert D. Shedd, Patent Operations;THOMSON Licensing LLC, P.O. Box 5312, Princeton, NJ, 08543-5312, US

(73) Assignee: THOMSON LICENSING LLC, Boulogne-Billancourt (FR)

(21) Appl. No.: 12/448,176

(22) PCT Filed: Dec. 10, 2007
(86) PCT No.: PCT/EP2007/063601

§ 371 Date: Jun. 11, 2009

(30) Foreign Application Priority Data
Dec. 14, 2006 (EP) 06126143.4

(51) Int. Cl. G11B 7/24

(52) U.S. Cl. 369/275.4; G9B/7.031

(57) ABSTRACT

The optical storage medium comprises a substrate layer and a data layer with a mark/space structure arranged in tracks, wherein a sequence of marks of a first track have a first width, and a sequence of marks of a neighboring track have a second width being different from the first width. The optical storage medium is in particular an optical disc, on which the tracks are arranged as spirals, circular rings or segmented circular rings.

### TECHNICAL FIELD OF THE INVENTION

The present invention relates to an optical storage medium, which comprises a substrate layer, a read-only data layer with a mark/space structure, in particular a pit/land structure, arranged in tracks on the substrate layer, and to a respective production of the optical storage medium. The optical storage medium comprises in a preferred embodiment a mask layer with a super resolution near field structure for storing of data with a high data density.

### BACKGROUND OF THE INVENTION

Optical storage media are media in which data are stored in an optically readable manner, for example by means of a pickup comprising a laser for illuminating the optical storage medium and a photo-detector for detecting the reflected light of the laser beam when reading the data. In the meanwhile a large variety of optical storage media are available, which are operated with different laser wavelength, and which have different sizes for providing storage capacities from below one Gigabyte up to 50 Gigabyte (GB). The formats include read-only formats (ROM) such as Audio CD and Video DVD, write-once optical media as well as rewritable formats. Digital data are stored on these media along tracks in one or more layers of the media.

The storage medium with the highest data capacity is at present the Blu-Ray disc (BD), which allows to store 50 GB on a dual layer disc. Available formats are at present for example read-only BD-ROM, re-writable BD-RE and write once BD-R discs. For reading and writing of a Blu-Ray disc an optical pickup with a laser wavelength of 405 nm is used. On the Blu-Ray disc a track pitch of 320 nm and a mark length from 2T to 8T, maximum 9T, is used, where T is the channel bit length, which corresponds with a length of 69-80 nm. Further information about the Blu-Ray disc system is available for example from the Blu-Ray group via Internet: www.blu-raydisc.com.

New optical storage media with a super-resolution near-field structure (Super-RENS) offer the possibility to increase the data density of the optical storage medium by a factor of three to four in one dimension in comparison with the Blu-Ray disc. This is possible by using a so-called Super-RENS structure or layer, which is placed above the data layer of the optical storage medium, and which significantly reduces the effective size of a light spot used for reading from or writing to the optical storage medium. The super-resolution layer is also called a mask layer because it is arranged above the data layer and by using specific materials only the high intensity center part of a laser beam can penetrate the mask layer. Also other mechanisms for super-resolution are known, e.g. by using a mask layer which shows an increased reflectivity at higher laser power.

The Super-RENS effect allows to record and read data stored in marks of an optical disc, which have a size below the resolution limit of a laser beam used for reading or writing the data on the disc. As known, the diffraction limit of the resolution of a laser beam is about lambda/(2*NA) according to Abbe, where lambda is the wavelength and NA the numerical aperture of the objective lens of the optical pickup.

A Super-RENS optical disc comprising a super-resolution near-field structure formed of a metal oxide or a polymer compound for recording of data and a phase change layer formed of a GeSbTe or a AgInSbTe based structure for reproducing of data is known from WO 2005/081242 and US 2004/0257968. Further examples of super-resolution optical media are described in WO 2004/032123 and by Tominaga et al., Appl. Phys. Lett. Vol. 73, No. 15, 12 Oct. 1998.

The super RENS effect allows to increase the resolution of the optical pickup for reading of the marks on an optical disc in track direction, but does not allow to reduce the track pitch.

In EP-A-0814464 an optical disc is described which comprises a mark train which has at least one shortest mark and at least one other mark, and in which the shortest mark of the mark train has a width larger than that of the other marks. By increasing the width of the shortest mark on the optical disc, the data signal resulting from a light beam reflected from the disc can be improved therefore, when reading data on the disc, in particular when the length of the shortest mark is smaller than the diameter of the reproducing light beam as applied to the disc.

### SUMMARY OF THE INVENTION

The optical storage medium according to the present invention comprises a substrate layer and a data layer with marks and spaces arranged in tracks of the data layer, wherein marks of neighboring tracks have different width. In particular, the width of marks of consecutive neighboring tracks is alternating, for example between a first width and a second width. The tracks may comprise sequences of marks, in which all marks of a respective sequence have the same or essentially the same width, and the width of marks of consecutive sequences is alternating. Alternatively, also tracks with marks may be utilized, for which the width of marks of consecutive neighboring tracks is alternating between three different widths or even more different widths. The optical disc is in particular a ROM disc comprising pits and lands as marks and spaces, but it can be also a writable or rewritable disc.

In a first preferred embodiment, the tracks constitute a single spiral arranged on an optical disc, the spiral comprising sequences of marks of different width, which width changes alternatingly between a first width of a sequence and a second width for a consecutive sequence, or changes alternatingly between a first width, a second width and a third width for consecutive sequences. The length of a sequence corresponds advantageously with the circumference of 360°, which fulfills the requirement that neighboring tracks of any track have always marks with different width.

In a second preferred embodiment, the optical storage medium is an optical disc comprising tracks being arranged in two or more spirals, wherein each spiral contains only marks of the same width, and wherein the width of marks of different spirals is each different. The optical disc contains for example two spirals having marks of different width, and one spiral is nested in between the other, so that the width of marks of neighboring tracks is always different with regard to any track.

In a further aspect of the invention, the optical storage medium is a Super-RENS optical disc, comprising a mask layer having a super resolution near field structure, and the track pitch between neighboring tracks is below the optical resolution limit of a corresponding optical pick-up. The track pitch is in particular below 280 nm for use with an optical pick-up having a semiconductor laser emitting light with a blue or violet wavelength, e.g. 405 nm. By using a track structure of this kind, where marks of neighboring tracks have alternatingly different widths, a push-pull signal can still be obtained for a tracking regulation of the optical pick-up. The data density for a Super-RENS disc can be increased therefore considerably, when using a track pitch below the optical resolution limit, for example by a factor of ¾ when using a track pitch of 240 nm instead of 320 nm, which is the standard track pitch for a Blu-Ray disc.

The mastering of a stamper for an optical disc in accordance with the first preferred embodiment can be made, by switching the intensity and/or width of the mastering beam, or by switching the amplitude of an high-frequency oscillation in radial direction of the mastering beam, between two different values after each full rotation of the master, for writing a sequence of data with marks with a certain width, for producing sequences with the length of a circumference, equal to 360° rotation, or is switched more often, when shorter sequences are used, for producing alternating pit widths for neighboring tracks. When reading the data of such a disc, the track polarity has to be switched correspondingly, when the width of a consecutive sequence changes.

For mastering an optical disc comprising two separate nested spirals having marks of different width, each spiral has to be mastered separately, and when mastering the second spiral, the master has to be precisely aligned with regard to the first spiral. Moreover, it may be possible to master both spirals at the same time by using specialized mastering equipment. The second preferred embodiment has the advantage that the read-out of the data is easier, because the track polarity has not to be switched when reading a certain spiral, but only when shifting from one spiral to the other spiral.

### BRIEF DESCRIPTION OF THE DRAWINGS

Preferred embodiments of the invention are explained now in more detail below by way of example with reference to schematic drawings, which show:

FIG. 1 a part of an optical storage medium in a cross section, having a layer structure comprising a substrate, a data layer and layer with a super resolution near field structure,

FIG. 2a a small area of an optical disc, on which specific tracks have only marks of a first width, and neighboring tracks with marks, which have only a second width being larger than the first width, the track pitch being below the optical resolution limit,

FIG. 2b a detector image of an optical pick-up for a track structure as shown in FIG. 2a,

FIG. 3a a small area of an optical disc, on which tracks have only marks of the same width and the track pitch is below the optical resolution limit,

FIG. 3b a detector image of an optical pick-up for a tracking structure as shown in FIG. 3a,

FIG. 4 calculated push-pull signals for tracking structures as shown in FIGS. 2a and 3a,

FIG. 5a a simplified sketch of an optical disc comprising a spiral having sequences of marks of two different widths, and

FIG. 5b a simplified sketch of an optical disc comprising a first spiral having only marks of a first width and a second spiral having only marks of a second width.

### DETAILED DESCRIPTION OF PREFERRED EMBODIMENTS

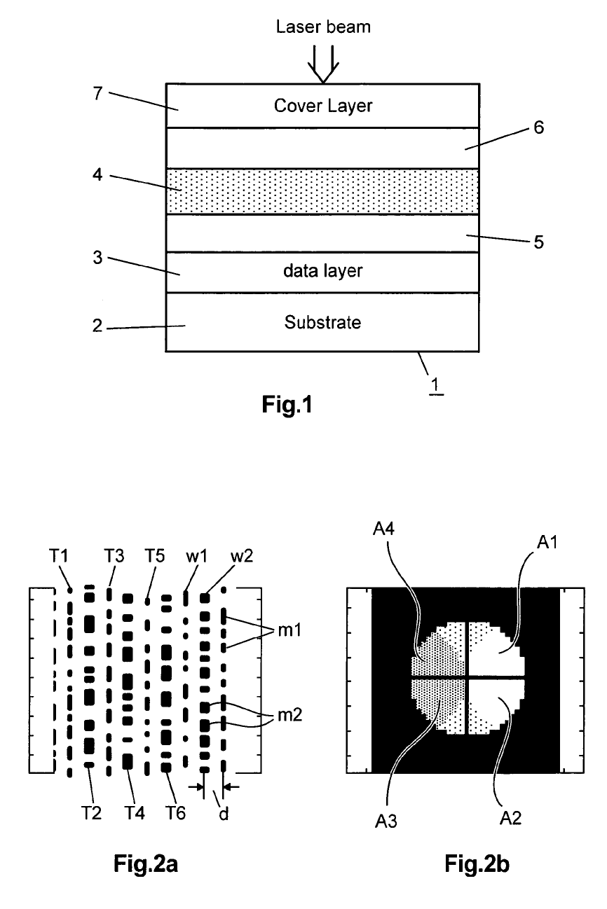

In FIG. 1 an optical storage medium 1 is shown in a cross section in a simplified manner, for example a read-only optical storage medium. On a substrate 2 a read-only data layer 3 is arranged comprising a reflective metallic layer, for example an aluminum layer, the data layer 3 having a data structure consisting of marks and spaces arranged on essentially parallel tracks. In the case of a ROM disc, the marks and spaces consist of pits and lands, the pits being molded or embossed on the surface of substrate 2 representing the data layer 3. On the data layer 3 a first dielectric layer 5 is arranged and on the dielectric layer 5 a mask layer 4 is arranged for providing a super-resolution near-field effect (Super-RENS). The optical storage medium 1 is in particular an optical disc having a size similar to DVDs and CDs.

Above the mask layer 4 a second dielectric layer 6 is arranged. As a further layer, a cover layer 7 is arranged on the second dielectric layer 5 as a protective layer. For reading the data of the data layer 3, a laser beam is applied from the top of the storage medium 1, penetrating first the cover layer 7. The first and second dielectric layers 5, 6 comprise for example the material ZnS—SiO₂. The substrate 2 and the cover layer 7 may consist of a plastic material, as known from DVDs and CDs. In other embodiments, the reflective metallic layer may be omitted, when a super-resolution near field structure is used, which does not provide an increase in transmittance due to a heating effect, but works with another Super-RENS effect.

With the Super-RENS effect, the resolution of an optical pick-up can be increased in track direction by a considerable amount, for example by a factor of three or four. This allows a reduction of the size of the marks and spaces of the tracks on the optical disc in track direction. But the Super-RENS effect as such does not allow to reduce the track pitch below the optical resolution limit of the pick-up unit. If a push-pull effect is used for the tracking regulation of the optical pick-up unit, the reduction of the track pitch is limited by the fact that the first order refracted beams have to be collected by the objective lens of the optical pick-up unit. Otherwise there is no push-pull signal, because this signal is generated by the interference of the 0^{th} order and the 1^{st} order beams as reflected from the optical storage medium. For a Blu-Ray pick-up this occurs at a track pitch of about 280 nm, the standard track pitch of a Blu-Ray disc is 320 nm.

To overcome this problem, the width of the marks changes alternatively between a first width W1 and a second width W2 such, that marks of neighboring tracks of the disc have different width, as shown in FIG. 2a. In FIG. 2a a small area of an optical disc is shown on which tracks T1, T3 and T5 have only marks m1 with a first width w1, and tracks T2, T4, T6 have marks m2, which have only a second width w2 being larger than the width w1. The tracks T1, T3, T5 are interleaved with the tracks T2, T4, T6 such, that the width of the marks of a first track is always different from the width of the marks of the neighboring tracks. The marks m1 of a first track T3 in particular have all the same width w1, or at least essentially the same when considering production fluctuations, and the marks M2 of the corresponding neighboring tracks T2, T4 in particular also have all the same or essentially the same width w2. The width w1, w2 is further independent or essentially independent of the length of the respective marks M1, M2, as shown in FIG. 2a.

By using such a kind of track structure, the track pitch d between two neighboring tracks T1, T2 can be reduced below the optical resolution limit of a corresponding optical pick-up by still providing the possibility to read the data of the tracks. In FIG. 2b a simulated image is shown as would appear on a respective detector of the optical pick-up having area segments A1-A4, when the track pitch d is 240 nm and a pick-up with a blue laser having a wavelength of 405 nm is used for a track structure as shown in FIG. 2a. In the FIG. 2b, overlapping areas of the first diffraction orders of the reflected beam can be clearly seen in the area segments A1-A4, which result in a push-pull signal, which can be used as a tracking information for providing tracking regulation of the optical pick-up.

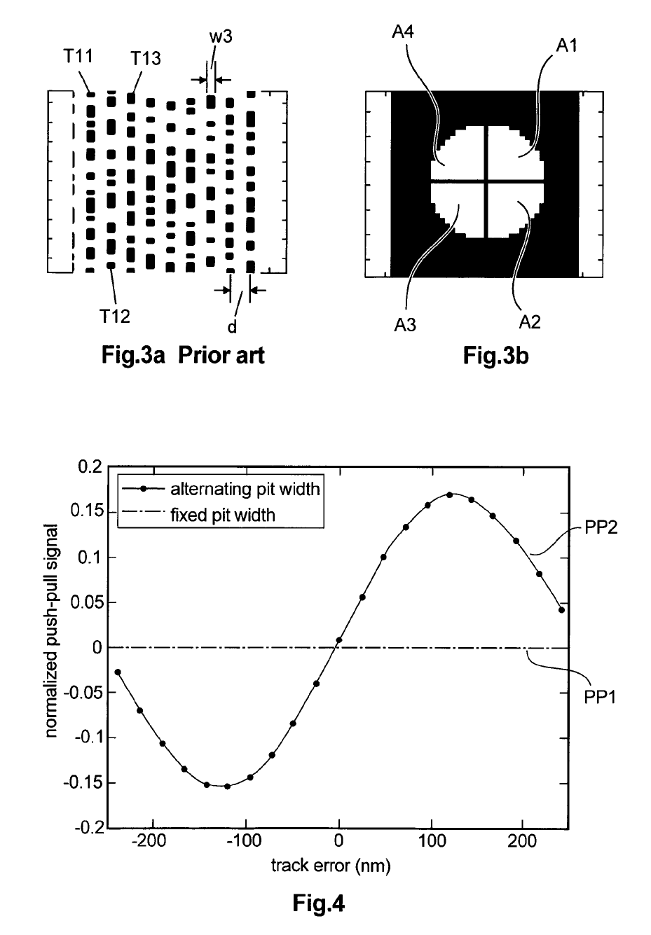

For comparison, in FIG. 3a a small area of an optical disc is shown having tracks T11-T13, which have all the same width w3 and also a track pitch d of 240 nm. This track structure results in a simulated detector image, FIG. 3b, which shows no overlap of the 0^{th} order and the 1^{st} first order reflected beams.

The track structure of FIG. 3a therefore does not provide a usable push pull signal PP1 as shown in FIG. 4, when the track pitch d is below the optical resolution limit. But the track structure of the FIG. 2a provides a clear normalized push pull signal PP2 for a track pitch of d=240 nm, which can be used for a tracking regulation of the optical pick-up.

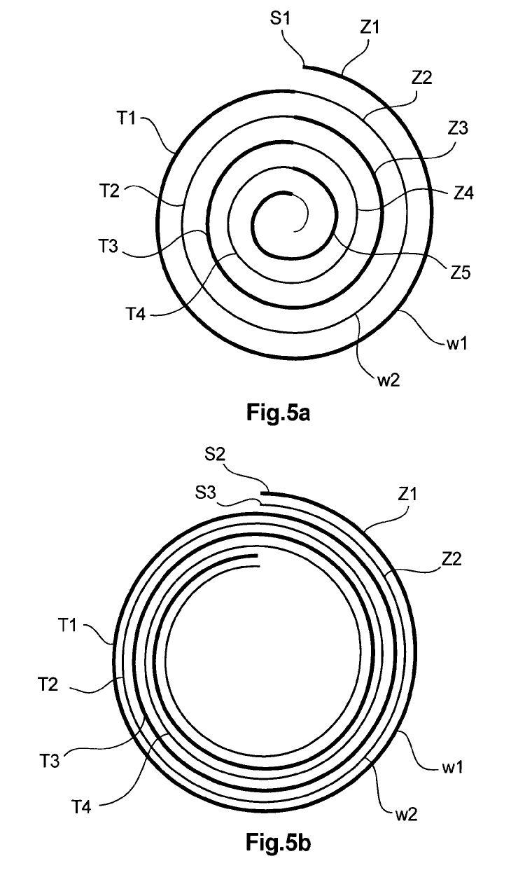

The tracks as shown in FIG. 2a may be arranged on the optical disc in form of spirals, as known from a DVD or a Blu-Ray disc, or in form of circular rings or segments of circular rings, as known from DVD-RAM. In FIG. 5a an embodiment is shown, in which tracks T1, T2, T3, . . . are arranged as one spiral S1 on an optical disc. To provide the requirement, that the mark width of neighboring tracks T1, T3 changes with regard to a specific track T2, the width of the marks as arranged in the spiral S1 has to change periodically between the width w1 and w2. This can be made by partitioning the spiral S1 into sequences Z1, Z3, Z5, . . . , which have only marks of the first width w1, and interleaved sequences Z2, Z4, . . . which contain only marks with the width w2. When the length of each of the segments Z1-Z5 has the length of one revolution respectively 360°, the requirement is fulfilled, that the mark width of a neighboring track is always different with regard to any track, as can be seen in FIG. 5a.

The length of the sequences Z1, Z2, . . . can be alternatively also smaller, and in particular, if successive sequences have a length of 1/(1+2n) of a perimeter of 360°, it can be easily shown that the requirement is also fulfilled, that the width of marks of one of the tracks is always different from the width of marks of the neighboring tracks, when n=1, 2, 3, . . . . But an optical disc with shorter sequences is more difficult to master, and therefore sequences Z1, Z2, . . . having the length of the perimeter of 360° seem to be an optimum, and sequences with a length of at least smaller than 360°/20 seem to be no more useful.

A second embodiment is shown in FIG. 5b, in which tracks T1-T4 are arranged as two spirals S2, S3 on an optical disc. The first spiral S2 comprises only marks with the first width w1, tracks T1, T3, and the second spiral S3 comprises only marks with the second width w2, tracks T2, T4, w2 being smaller than the first width w1. The first spiral S2 is interleaved with the second spiral S3 such, that the tracks T1, T3 belong to the first spiral S2, and the tracks T2, T4 of the second spiral S3 are correspondingly interleaved between the tracks T1, T3. For such an arrangement then also the condition is fulfilled, that the width of marks of one of the tracks is always different from the width of marks of the neighboring tracks. Therefore, both embodiments correspond with the track pattern as shown in FIG. 2a, and therefore a push-pull signal can be obtained even, when the track pitch is below the optical resolution limit. The embodiments as shown in FIGS. 5a and 5b do not represent a real optical disc, but show only a very simplified sketch just to explain the present invention.

The different arrangements as shown in the embodiments of FIGS. 5a and 5b have respective consequences for the tracking regulation, when reading the data of the tracks with a real optical pick-up. Because the width of the spiral S1 of the embodiment of FIG. 5a changes periodically, also the sign of the push-pull signal changes correspondingly, which requires that the tracking regulation has to work periodically with a positive and negative track polarity of the push-pull signal. When reading data from a disc having two spirals as shown in FIG. 5b, it is advantageous to read first one spiral completely or a large part of one spiral completely, and then switch to the other spiral. For switching from one spiral to the other spiral, the tracking regulation has to be adjusted correspondingly from positive to negative track polarity.

A continued read-out of a complete disc with two spirals as shown in FIG. 5b can be made for example with the following procedure: First, M tracks of for example spiral S2 are read without moving the complete optical pick-up, by only moving the actuator of the optical pick-up. Then the actuator moves back quickly, crossing at least M tracks, changing track polarity of the tracking regulation for shifting to the second spiral S3, and then M tracks or even 2M tracks of spiral S3 can be red continuously. For reading the tracks M+1-2M it might be necessary to move the complete pick-up. This sequence of steps can be continued then for reading alternatingly tracks of the first width w1 and the second width w2.

To enable this type of read-out of the marks in the correct sequence, it is required that during the authoring of the disc it has to be determined and marked where the actuator has to move back and how many tracks it should cross. It has to be mentioned that the quality of the high frequency signal read-out signal of the data of the optical disc depends on the pit geometry. Because of the variation of the pit width, not all pits can have the optimized width for the high frequency signal. To achieve a constant quality for the high frequency signal, both widths w1, w2 should deviate from the optimized width such that the influence on the high frequency signal will be comparable for both widths. The smaller width w2 for the pits respectively marks should be therefore below the optimum width for the high frequency signal, and the larger width w1 of the marks should be correspondingly above the optimum width.

In principle, the idea of using different width of the marks for neighboring tracks is not limited to the use of only two different widths w1, w2. By using three or even more different mark widths, the effective periodicity could be increased by a factor of three or even more. This enables a further reduction of the actual track pitch as compared to a conventional disc with a uniform pit width.

The mastering of a stamper for an optical disc in accordance with the embodiment as shown in FIG. 5a can be made, by switching the intensity and/or width of the mastering beam between two different values after each full rotation of the master, for writing a sequence of data with marks with a certain width, for example to produce a sequence with the length of a circumference, equal to 360° rotation, with a width w1, and in the next step, to produce a sequence with the length of a circumference equal to 360° with a width w2. When the length of a sequence is shorter than a circumference, then the intensity and/or width of the mastering beam has to be switched more often, for producing alternating pit widths for neighboring tracks. For producing a single spiral having marks of different widths in accordance with FIG. 5a, also for producing a two or more spirals in accordance with FIG. 5b, it is advantageous to use an electron beam mastering and to adjust the wobble amplitude of the electron beam in accordance with a selected width.

For mastering an optical disc comprising two separate nested spirals having marks of different width, as shown in FIG. 5b, each spiral has to be mastered separately, and when mastering the second spiral, the master has to be precisely aligned with regard to the first spiral. Moreover, it may be possible to master both spirals at the same time by using specialized mastering equipment. The second preferred embodiment has the advantage that the read-out of the data is easier, because the track polarity has not to be switched when reading a certain spiral, but only when shifting from one spiral to the other spiral.

The track structures as shown in FIGS. 2a, 5a, 5b can be applied advantageously for a Super-RENS optical disc, comprising a mask layer having a super resolution near field structure, as described with regard to FIG. 1. The track pitch is in particular below 280 nm for use with an optical pick-up having a semiconductor laser emitting light with a wavelength of e.g. about 405 nm. But also other embodiments may be utilized by a person skilled in the art without departing from the spirit and scope of the present invention. The invention may be used particularly not only for read-only (ROM) optical storage media, but also for writable and re-writable optical storage media. The invention resides therefore in the claims herein after appended.

1-15. (canceled)

16. Optical storage medium comprising a substrate layer and a data layer with a mark/space structure arranged in tracks forming a spiral, wherein
a sequence of marks of a first track have a first width, and a sequence of marks of a neighboring track have a second width being different from the first width,
the width of marks of consecutive neighboring tracks is alternating between the first width and the second width or between a first width, a second width and a third width, and
said sequences being arranged within a single spiral.

17. The optical storage medium according to claim 16, wherein the optical storage medium is an optical disc.

18. The optical storage medium according to claim 16, wherein said sequences change alternatingly between the first width and the second width for consecutive sequences.

19. The optical storage medium according to claim 18, wherein the mark width of the spiral changes after one revolution, or after 1/(1+2n) of a revolution with n=1, 2, 3, . . . , between the first width and the second width.

20. The optical storage medium according to claim 18, wherein the track pitch between neighboring tracks of the optical disc is below the optical resolution limit of a corresponding optical pick-up, and in particular below 280 nm, for use with an optical pick-up having a semiconductor laser emitting light with a wavelength of about 405 nm.

21. Optical storage medium according to claim 20, wherein the optical storage medium is a read only optical disc comprising a mark/space structure represented as pits and lands.

22. Optical storage medium according to claim 20, wherein the optical storage medium is a Super-RENS disc comprising a mask layer with a super resolution near field structure, and wherein the track pitch between neighboring tracks is below the optical resolution limit, in particular below 280 nm when the storage medium is designed for use with an optical pick-up having a laser with a wavelength in a range of 400-450 nm.

23. Method for manufacturing a stamper for an optical storage medium in accordance with claim 17, comprising the step of switching the intensity and/or width of the mastering beam periodically between a first and a second width, or a first width, a second width and a third width, for producing consecutive sequences of marks having different width.

24. Method for producing a stamper for an optical storage medium in accordance with claim 23, comprising the step of mastering a spiral by using an electron beam mastering and adjusting the wobble amplitude of the electron beam in accordance with a selected width.

25. Apparatus comprising an optical pick-up for reading data from an optical storage medium in accordance with claim 16, wherein the apparatus comprises a tracking regulation, with switches a track polarity or a phase relation of the push-pull signal, for reading a track or sequence of marks of a different width.

26. Apparatus in accordance with claim 25, wherein the tracking regulation selects marks of a first, a second or a third width in accordance with the track polarity or the phase relation of the push-pull signal.

27. Apparatus in accordance with claim 26, wherein the apparatus reads and decodes a sequence of information bits arranged as marks and spaces before a changeover of a width of marks along a spiral, the information bits informing the tracking regulation about the position to switch the track polarity or the phase relation of the push-pull signal, for reading data of a spiral comprising marks of different widths.
